(19) United States
(12) Patent Application Publication
(10) Pub. No.: US 2021/0333614 A1
(43) Pub. Date: Oct. 28, 2021

(54) DISPLAY PANEL

(71) Applicant: Shenzhen China Star Optoelectronics Semiconductor Display Technology Co., Ltd., Shenzhen (CN)

(72) Inventor: Lixuan CHEN, Shenzhen (CN)

(73) Assignee: Shenzhen China Star Optoelectronics Semiconductor Display Technology Co., Ltd., Shenzhen (CN)

(21) Appl. No.: 16/624,316

(22) PCT Filed: Dec. 3, 2019
(86) PCT No.: PCT/CN2019/122578

§ 371 Date: Dec. 19, 2019

(30) Foreign Application Priority Data
Jul. 22, 2019 (CN) 201910662361.5

(51) Int. Cl. G02F 1/1333; G02F 1/1343

(52) U.S. Cl. CPC G02F 1/133337; G02F 1/133345; G02F 1/13685; G02F 1/13439; G02F 1/134336

(57) ABSTRACT

A display panel includes a base substrate, a thin-film transistor layer, a planarization layer, a plurality of pixel electrodes, and a pixel definition layer. The present invention provides an improved pixel electrode design by dividing a conventional pixel electrode of an array substrate into a first electrode layer and a second electrode layer. The first electrode layer is used as a blocking layer to block ions of an organic planarization layer from entering a base layer and a liquid crystal layer, so that a problem of abnormal image retention of a display panel can be solved in the end.

This application claims the priority of China Patent Application serial No. 201910662361.5, filed Jul. 22, 2019, titled “display panel”, and the disclosures of which are incorporated herein by reference in their entirety.

### BACKGROUND OF INVENTION

### 1. Field of Invention

The present invention relates to a technical field of displays, and particularly to, a display panel.

### 2. Related Art

According to theoretical calculations of liquid crystal optics, in a process of preparing a vertically aligned liquid crystal display (VA LCD), a transmittance is: T=0.5*sin 2 (2φ) sin 2 (pi*Δnd/λ). The angle φ is deflected to a position of 45 degrees. At this time, a polarization direction of incident light is deflected by 90 degrees after passing through liquid crystal layers, and the transmittance is maximum now. Therefore, in current VA LCD design, general pixel electrode (indium tin oxide, ITO) patterns are arranged at 45 degrees in a horizontal/vertical direction, so that when voltages are applied for driving, liquid crystal molecules can be arranged in a direction of φ=45 degrees.

In current design, in a structure using organic planarization layers (polymer film on array, PFA) instead of passivation layers, since the organic planarization layers are affected by chemical processes during synthesis, they are easy to leave impurities and ions. Especially, after display devices are fabricated, PFA is prone to a problem of ion precipitation, causing ions to enter the liquid crystal layers and adversely affect its resistivity, and then affect image retention results.

Therefore, it is imperative to provide a novel display panel to improve stability of the display panel, and to solve a problem of abnormal image retention that may also be affected by changes in resistivity and capacitance in prior art.

### SUMMARY OF INVENTION

An object of the present invention is to provide a display panel and to divide a conventional pixel electrode on a side of an array substrate into a first electrode layer and a second electrode layer. The first electrode layer is used as a blocking layer to block ions of a polymer film on array (PFA) from entering a base layer and a liquid crystal layer, thereby to solve a problem of abnormal image retention of a display panel.

The present invention provides a display panel, comprising a base substrate; a thin-film transistor layer disposed on the base substrate; a planarization layer disposed on a side of the thin-film transistor layer away from the base substrate; a plurality of pixel electrodes disposed on a side of the planarization layer away from the thin-film transistor layer; and a pixel definition layer disposed on a side of the planarization layer away from the thin-film transistor layer; wherein the pixel definition layer comprises a plurality of open slots extending through the pixel definition layer to the pixel electrodes.

Further, the pixel electrodes comprise a first electrode layer and a second electrode layer disposed on the first electrode layer.

Further, the planarization layer comprises a plurality of grooves, wherein each of the grooves is disposed corresponding to one of the open slots, the pixel electrodes are disposed in the grooves, and each of the grooves has a depth between 30 nanometers (nm) and 50 nm.

Further, the first electrode layer has a thickness designated as h1, and the second electrode layer has a thickness designated as h2, wherein a relation between the thickness of the first electrode layer and the thickness of the second electrode layer is h1<a*h2, and a is ranged between 0.5 nm and 1.2 nm, and the thickness h2 is greater than 10 nm but less than 200 nm.

Further, the first electrode layer has an electrical conductivity less than that of the second electrode layer, the first electrode layer and the second electrode layer are fabricated through a halftone mask process, and a gap is disposed between adjacent two of the pixel electrodes.

Further, the second electrode layer comprises a main trunk being cross-like in shape; a plurality of pixel electrode branches connected to the main trunk and extending in different directions; and a sealing frame connected with ends of the pixel electrode branches and the main trunk.

Further, the pixel electrode branches extend at angles of 45°, 135°, −135°, and −45° with respect to a horizontal direction, respectively.

Further, the thin-film transistor layer comprises a semiconductor layer disposed on a side of the base substrate; a first gate insulating layer disposed on the side of the base substrate and the semiconductor layer; a first gate disposed on a side of the first gate insulating layer away from the base substrate; a second gate insulating layer disposed on the first gate insulting layer and the first gate layer; a second gate disposed on aside of the second gate insulating layer away from the first gate insulating layer; an interlayer dielectric layer disposed on the second gate layer and the second gate insulating layer; and a source/drain layer disposed on a side of the interlayer dielectric layer away from the second gate insulating layer.

Further, the source/drain layer comprises a source electrode and a drain electrode, and the semiconductor layer comprises a drain area and a source area, wherein the source electrode extends through the interlayer dielectric layer to the source area, and the drain electrode extends through the interlayer dielectric layer to the drain area.

Further, the first electrode layer is connected to the source electrode or the drain electrode.

The present invention has advantageous effects as follows: the present invention provides a display panel, and brings about an improved pixel electrode design by dividing a conventional pixel electrode of an array substrate into the first electrode layer and the second electrode layer. The first electrode layer is used as a blocking layer to block ions of a polymer film on array (PFA) from entering a base layer and a liquid crystal layer, so that a problem of abnormal image retention of a display panel can be solved finally.

The second electrode layer functions as a pattern layer. With appropriate adjustment of a height relation between upper and lower layers of the pixel electrodes, an electric field direction of degrees can be maintained. Furthermore, after the height relation between the first electrode layer and the second electrode layer is appropriately adjusted, an electric field at edges of the pixel electrodes becomes more uniform, which is advantageous to improve transmittance of edge areas of the pixel electrodes.

### BRIEF DESCRIPTION OF DRAWINGS

The invention is further described below with reference to the drawings and embodiments.

FIG. 1 is a schematic structural view of a display panel of an embodiment of the present invention.

FIG. 2 is a schematic plan view of an electrode pattern of a second electrode layer of an embodiment of the present invention.

FIG. 3 shows an electric field distribution diagram of a conventional pixel electrode structure.

FIG. 4 shows an electric field distribution diagram of a pixel electrode structure of an embodiment of the present invention.

FIG. 5 is an interlaced electric field distribution diagram of a pixel electrode structure of an embodiment of the present invention.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

Embodiments of the present invention will be described in detail herein with reference to the drawings. The invention may be embodied in many different forms, and the invention should not be construed as merely the specific embodiments set forth herein. The embodiments are provided to explain the practical application of the present invention, so that those skilled in the art can understand various embodiments of the present invention and various modifications suitable for a specific intended application.

In the present invention, unless otherwise explicitly specified or limited, the terms “mounted”, “linked”, “connected”, and like terms are to be broadly understood. For example, it may be a fixed connection, a detachably connection, or an integrally connection, or may be a mechanical connection, electrically connection, or a directly connection. Alternatively, it can also be connected indirectly through intervening structures, or may be interaction between the two internal communicating elements or two elements. Those of ordinary skill in the art, to be understood that the specific meanings in the present invention in accordance with specific circumstances.

The present invention provides a display panel including a base substrate; a thin-film transistor layer disposed on the base substrate; a planarization layer disposed on a side of the thin-film transistor layer away from the base substrate; a plurality of pixel electrodes disposed on a side of the planarization layer away from the thin-film transistor layer; and a pixel definition layer disposed on a side of the planarization layer away from the thin-film transistor layer, wherein the pixel definition layer includes a plurality of open slots extending through the pixel definition layer to the pixel electrodes.

Preferably, the pixel electrodes include a first electrode layer and a second electrode layer disposed on the first electrode layer.

Preferably, the planarization layer includes a plurality of grooves, wherein each of the grooves is disposed corresponding to one of the open slots, the pixel electrodes are disposed in the grooves, and each of the grooves has a depth between 30 nanometers (nm) and 50 nm.

Preferably, the first electrode layer has a thickness designated as h1, and the second electrode layer has a thickness designated as h2, wherein a relation between the thickness of the first electrode layer and the thickness of the second electrode layer is h1<a*h2, and a is ranged between 0.5 nm and 1.5 nm, and the thickness h2 is greater than 10 nm but less than 200 nm.

Preferably, the first electrode layer has an electrical conductivity less than that of the second electrode layer, and the first electrode layer and the second electrode layer are fabricated through a halftone mask process.

Preferably, a gap is disposed between adjacent two of the pixel electrodes.

Preferably, the second electrode layer includes a main trunk being cross-like in shape; a plurality of pixel electrode branches connected to the main trunk and extending in different directions; and a sealing frame connected with ends of the pixel electrode branches and the main trunk.

Preferably, the pixel electrode branches extend at angles of 45°, 135°, −135°, and −45° with respect to a horizontal direction, respectively.

Preferably, the thin-film transistor layer includes a semiconductor layer disposed on a side of the base substrate; a first gate insulating layer disposed on the side of the base substrate and the semiconductor layer; a first gate disposed on a side of the first gate insulating layer away from the base substrate; a second gate insulating layer disposed on the first gate insulting layer and the first gate layer; a second gate disposed on aside of the second gate insulating layer away from the first gate insulating layer; an interlayer dielectric layer disposed on the second gate layer and the second gate insulating layer; and a source/drain layer disposed on a side of the interlayer dielectric layer away from the second gate insulating layer.

Preferably, the source/drain layer includes a source electrode and a drain electrode, and the semiconductor layer includes a drain area and a source area. The source electrode extends through the interlayer dielectric layer to the source area, and the drain electrode extends through the interlayer dielectric layer to the drain area.

Preferably, the first electrode layer is connected to the source electrode or the drain electrode.

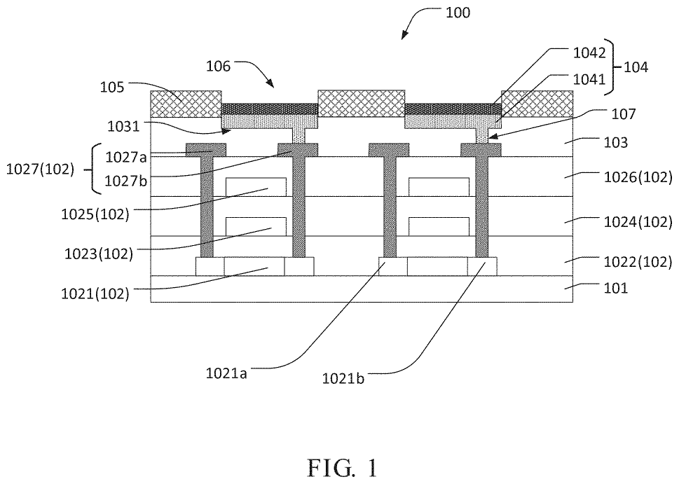

As shown in FIG. 1, in one embodiment, a display panel 100 of the present invention provides a base substrate 101, a thin-film transistor layer 102, a planarization layer 103, a plurality of pixel electrodes 104, and a pixel definition layer 105.

In this embodiment, the base substrate 101 is a transparent substrate. The thin-film transistor layer 102 functions as a switch and is mainly configured to drive the pixel electrodes 104.

The thin-film transistor layer 102 includes a semiconductor layer 1021, a first gate insulating layer 1022, a first gate 1023, a second gate insulating layer 1024, a second gate 1025, an interlayer dielectric layer 1026, and a source/drain layer 1027.

The semiconductor layer 1021 is disposed on a side of the base substrate 101 and includes a drain area 1021b and a source area 1021a.

The first gate insulating layer 1022 is disposed on the base substrate 101 and the semiconductor layer 1021. The first gate insulating layer 1022 functions to insulate adjacent metal layers to avoid being affected.

The first gate 1023 is disposed on a side of the first gate insulating layer 1022 away from the base substrate 101. The second gate insulating layer 1024 is disposed on the first gate insulating layer 1022 and the first gate 1023. The second gate 1025 is disposed on a side of the second gate insulating layer 1024 away from the first gate insulating layer 1022. The interlayer dielectric layer 1026 is disposed on the second gate layer 1025 and the second gate insulating layer 1024.

The source/drain layer 1027 is disposed on a side of the interlayer dielectric layer 1026 away from the second gate insulating layer 1024. The source/drain layer 1027 includes a source electrode 1027a and a drain electrode 1027b.

The source electrode 1027a extends through the interlayer dielectric layer 1026 to the source area 1021a, and the drain electrode 1021b extends through the interlayer dielectric layer 1026 to the drain area 1021b.

The planarization layer 103 is disposed on a side of the thin-film transistor layer 102 away from the base substrate 101. The planarization layer 103 is prepared by a coating method. The pixel electrodes 104 are disposed a side of the planarization layer 103 away from the thin-film transistor layer 102.

The pixel definition layer 105 is disposed on the side of the planarization layer 103 away from the thin-film transistor layer 102. The pixel definition layer 105 includes a plurality of open slots 106 each extending through the pixel definition layer 105 to the pixel electrodes 104. That is, each of the pixel electrodes 104 is exposed in a corresponding one of the open slots 106.

The planarization layer 103 includes a plurality of grooves 1031. Each of the grooves 1031 is disposed corresponding to one of the open slots 106, and the pixel electrodes 104 are disposed in the grooves 1031. Each of the grooves 1031 has a depth between 30 nanometers (nm) and 50 nm, preferably 40 nm, or may also be 35 nm or 45 nm.

In this manner, the pixel electrodes 104 protrude from the planarization layer 103 to a height less than 10 nm so that liquid crystal efficiency can be improved and light leakage in a dark state can be reduced.

The pixel electrodes 104 include a first electrode layer 1041 and a second electrode layer 1042. The second electrode layer 1042 is disposed on the first electrode layer 1041, and the first electrode layer 1041 is disposed in the grooves 1031. The first electrode layer 1041 extends through a via hole 107 to be connected to the source electrode 1027a and the drain electrode 1027b. In this embodiment, the first electrode layer 1041 is connected to the drain electrode 1027b.

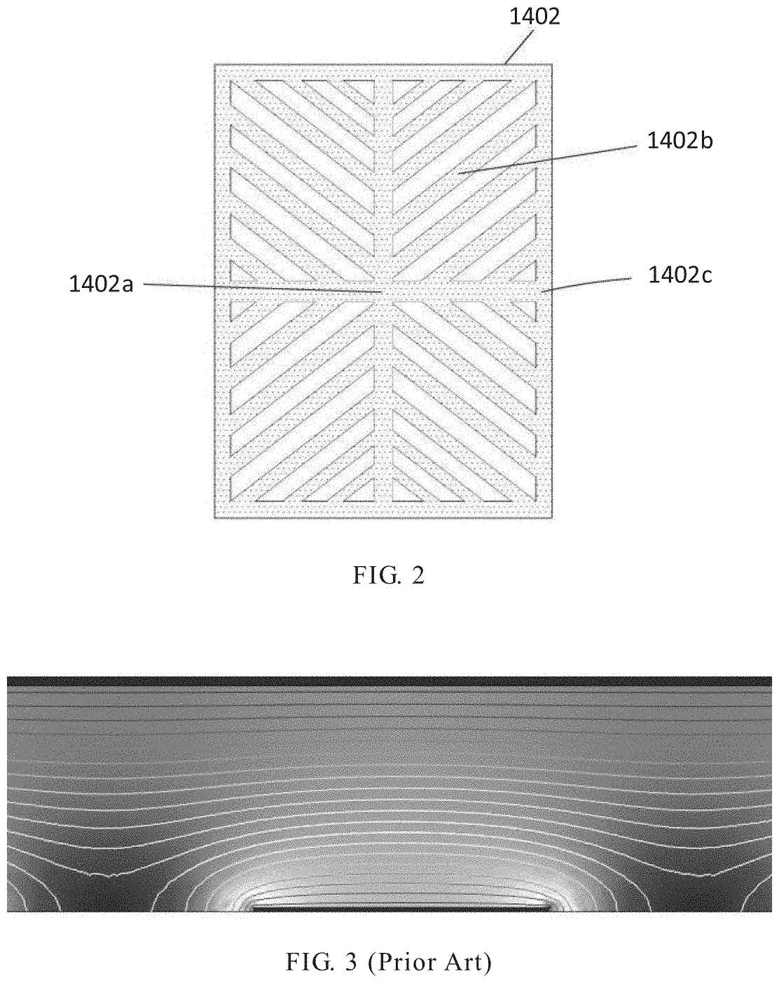

As shown in FIG. 2, an electrode pattern of the second electrode layer 1042 of one embodiment is shown in the figure drawing. In this embodiment, the second electrode layer 1042 includes a main trunk 1042a, a plurality of pixel electrode branches 1042b, and a sealing frame 1042c.

The main trunk 1042a is cross-like in shape. Each of the pixel electrode branches 1042b is connected to the main trunk 1042a and extends in a direction different from each other. The sealing frame 1042c is connected with ends of all the pixel electrode branches 1042b and the main trunk 1042a.

The pixel electrode branches 1042b extend at angles of 45°, 135°, −135°, and −45° with respect to a horizontal direction, respectively.

The first electrode layer has a thickness designated as h1, and the second electrode layer has a thickness designated as h2. A relation between the thickness of the first electrode layer and the second electrode layer is h1<a*h2, wherein a is ranged between 0.5 nm and 1.2 nm, and the thickness h2 is greater than 10 nm but less than 200 nm, that is, 10<h2<200 nm, preferably 100 nm, or may be 50 nm, 80 nm, 120 nm, 150 nm, or 180 nm.

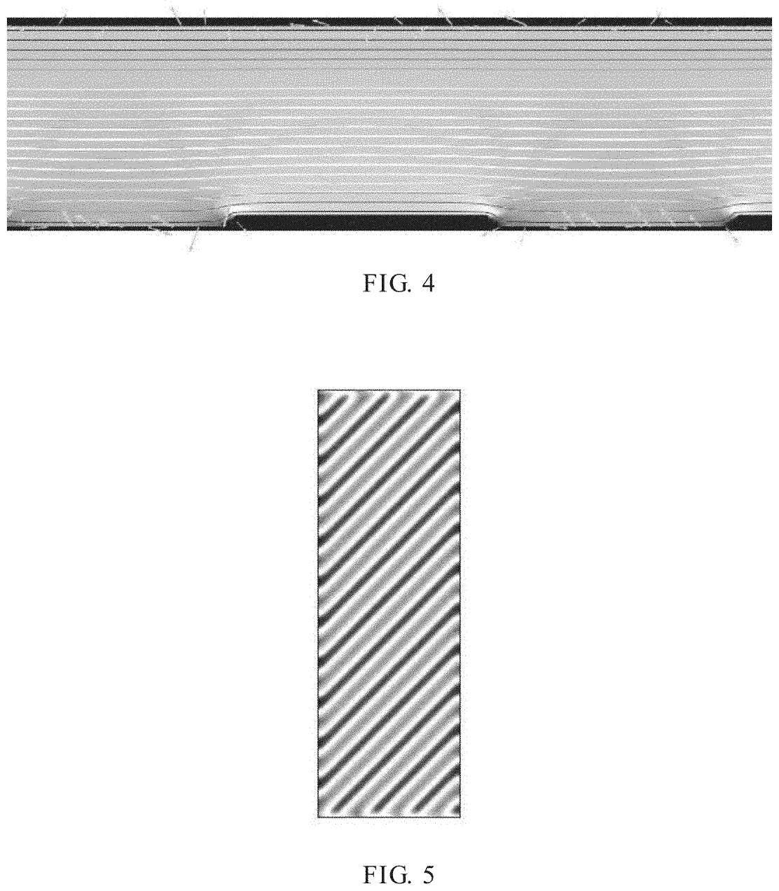

With appropriate adjustment of a thickness relation between the first electrode layer 1041 and the second electrode layer 1042, an electric field at edges of the pixel electrodes 104 becomes more uniform, which is advantageous to improve transmittance of edge areas of the pixel electrodes. For example, FIG. 4 shows an electric field distribution diagram of a pixel electrode structure of an embodiment of the present invention. In comparison with an electric field distribution under a conventional pixel electrode structure as shown in FIG. 3, an electric field at edges of the pixel electrodes 104 according to the present invention becomes more uniform.

Based on the pixel electrodes 104 configured with a two-layered structure, with appropriate adjustment of a height relation between upper and lower layers of the pixel electrodes 104, an electric field direction of 45 degrees can be maintained. As shown in FIG. 5, it shows an interlaced electric field distribution diagram of a pixel electrode structure of an embodiment of the present invention.

The first electrode layer 1041 and the second electrode layer 1042 are fabricated through a halftone mask process, and a gap is disposed between adjacent two of the pixel electrodes 14. The pixel electrodes 104 are arranged to be separate from each other by a one-time mask process.

The first electrode layer 1041 has an electrical conductivity less than that of the second electrode layer 1042, wherein the electrical conductivity is mainly adjusted by controlling oxygen content in the process.

The present invention provides a display panel 100, and brings about an improved pixel electrode design by dividing a pixel electrode of a conventional array substrate into the first electrode layer 1041 and the second electrode layer 1042. The first electrode layer 1041 is used as a blocking layer to block ions of PFA from entering a base layer and a liquid crystal layer (known as prior art and is not marked in the drawings), so that a problem of abnormal image retention of a display panel can be solved in the end.

The second electrode layer 1042 functions as a pattern layer. With appropriate adjustment of a height relation between upper and lower layers of the pixel electrodes, an electric field direction of 45 degrees can be maintained. Furthermore, after the height relation between the first electrode layer 1041 and the second electrode layer 1042 is appropriately adjusted, an electric field at edges of the pixel electrodes 104 becomes more uniform, which is advantageous to improve transmittance of edge areas of the pixel electrodes 104.

Accordingly, although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. A display panel, comprising:
a base substrate;
a thin-film transistor layer disposed on the base substrate;
a planarization layer disposed on a side of the thin-film transistor layer away from the base substrate;
a plurality of pixel electrodes disposed on a side of the planarization layer away from the thin-film transistor layer; and
a pixel definition layer disposed on a side of the planarization layer away from the thin-film transistor layer;
wherein the pixel definition layer comprises a plurality of open slots extending through the pixel definition layer to the pixel electrodes.

2. The display panel of claim 1, wherein the pixel electrodes comprise a first electrode layer and a second electrode layer disposed on the first electrode layer.

3. The display panel of claim 1, wherein the planarization layer comprises a plurality of grooves, wherein each of the grooves is disposed corresponding to one of the open slots, the pixel electrodes are disposed in the grooves, and each of the grooves has a depth between 30 nanometers (nm) and 50 nm.

4. The display panel of claim 2, wherein the first electrode layer has a thickness designated as h1, and the second electrode layer has a thickness designated as h2, wherein a relation between the thickness of the first electrode layer and the thickness of the second electrode layer is h1<a*h2, and a is ranged between 0.5 nm and 1.2 nm, and the thickness h2 is greater than 10 nm but less than 200 nm.

5. The display panel of claim 2, wherein the first electrode layer has an electrical conductivity less than that of the second electrode layer, the first electrode layer and the second electrode layer are fabricated through a halftone mask process, and a gap is disposed between adjacent two of the pixel electrodes.

6. The display panel of claim 2, wherein the second electrode layer comprises:
a main trunk being cross-like in shape;
a plurality of pixel electrode branches connected to the main trunk and extending in different directions; and
a sealing frame connected with ends of the pixel electrode branches and the main trunk.

7. The display panel of claim 6, wherein the pixel electrode branches extend at angles of 45°, 135°, −135°, and −45° with respect to a horizontal direction, respectively.

8. The display panel of claim 3, wherein the thin-film transistor layer comprises:
a semiconductor layer disposed on a side of the base substrate;
a first gate insulating layer disposed on the side of the base substrate and the semiconductor layer;
a first gate disposed on a side of the first gate insulating layer away from the base substrate;
a second gate insulating layer disposed on the first gate insulting layer and the first gate layer;
a second gate disposed on aside of the second gate insulating layer away from the first gate insulating layer;
an interlayer dielectric layer disposed on the second gate layer and the second gate insulating layer; and
a source/drain layer disposed on a side of the interlayer dielectric layer away from the second gate insulating layer.

9. The display panel of claim 8, wherein the source/drain layer comprises a source electrode and a drain electrode, and the semiconductor layer comprises a drain area and a source area, wherein the source electrode extends through the interlayer dielectric layer to the source area, and the drain electrode extends through the interlayer dielectric layer to the drain area.

10. The display panel of claim 8, wherein the first electrode layer is connected to the source electrode or the drain electrode.
